(19) United States
(12) Patent Application Publication
(10) Pub. No.: US 2026/0244028 A1
(43) Pub. Date: Aug. 20, 2026

(54) DUAL LENS BARREL OPTICAL DEVICE AND THE IMAGE STABILIZATION MODULE THEREOF

(71) Applicant: Asia Optical Co., Inc., Taichung (TW)

(72) Inventors: Sheng Luo, ShenZhen City (CN); Jiang-Lin Liu, ShenZhen City (CN); Fang-Li Ma, ShenZhen City (CN); Yue-Ye Chen, ShenZhen City (CN); Chia-Hsiao Huang, Taichung (TW); Ting-Rung Hsu, Taichung (TW); Yu-Xiu Lin, Taichung (TW); Shih-Gong Chen, Taichung (TW); Hua-Tang Liu, Taichung (TW)

(21) Appl. No.: 19/530,643

(22) Filed: Feb. 5, 2026

(30) Foreign Application Priority Data
Feb. 18, 2025 (CN) CN202510179857.2

(51) Int. Cl. G02B 27/64; G02B 7/02

(52) U.S. Cl. CPC G02B 27/646; G02B 7/02

(57) ABSTRACT

A dual lens barrel optical device includes an image stabilization module, a first lens barrel, a second lens barrel and a second lens assembly. The image stabilization module includes a first image stabilization mechanism and a second image stabilization. The first image stabilization mechanism is disposed in the first lens barrel. The first lens assembly has a first optical axis, and light passes through the first lens assembly to form a first image. The second lens assembly has a second optical axis, and light passes through the second lens assembly to form a second image. The first lens barrel and the second lens barrel are movable with respect to each other to change a distance between the first optical axis and the second optical axis, so that the first image and the second image have no parallax.

### BACKGROUND OF THE INVENTION

### FIELD OF THE INVENTION

The invention relates to the technical field of optical image stabilization for a dual lens barrel optical device, and more particularly to a dual lens barrel optical device and the image stabilization module thereof.

### DESCRIPTION OF THE RELATED ART

Conventional binoculars, which are able to adjust the distance between the lens barrels in accordance with user's eye width, include a first image stabilization mechanism OIS1 and a second image stabilization mechanism OIS2. In operation, the first image stabilization mechanism OIS1 detects the movement of the first lens barrel in accordance with a coordinate system (X-Y coordinate system) for driving a first lens of the first lens assembly to move in the X direction and Y direction, thereby compensating for the image formed by the first lens assembly. The second image stabilization mechanism OIS2 detects the movement of the second lens barrel in accordance with another coordinate system (X'-Y' coordinate system) for driving a second lens of the second lens assembly to move in the X' direction and Y' direction, thereby compensating for the image formed by the second lens assembly.

Referring to FIG. 1, in response to shaking of the binoculars, the first image stabilization mechanism OIS1 and the second image stabilization mechanism OIS2 are required to drive the first lens and the second lens to a target position P for shake compensation. However, when the shaking amplitude of the binoculars exceeds the maximum compensation range of the first image stabilization mechanism OIS1 and the second image stabilization mechanism OIS2, the first image stabilization mechanism OIS1 can only drive the first lens to a limit position P1 for shake compensation, and the second image stabilization mechanism OIS2 can also only drive the second lens to a limit position P2 for shake compensation. Because the coordinate systems used by the first image stabilization mechanism OIS1 and the second image stabilization mechanism OIS2 are different, their limit positions P1 and P2 may deviate from each other so that the first and second lenses are moved in different directions. Therefore, there are discrepancies between the images formed by the first lens assembly and the second lens assembly, resulting in parallax in user's vision that potentially causes dizziness and other discomfort.

### BRIEF SUMMARY OF THE INVENTION

The invention therefore provides a dual lens barrel optical device and the image stabilization module thereof to solve the described problem. Specifically, the invention can avoid the parallax in the image formed at user's eyes when the shaking amplitude of the binoculars exceeds the maximum compensation range of the first image stabilization mechanism and the second image stabilization mechanism.

The image stabilization module in accordance with an exemplary embodiment of the invention includes a first image stabilization mechanism and a second image stabilization mechanism. The first image stabilization mechanism includes a plurality of first sensors and a first compensation assembly wherein the first image stabilization mechanism is configured for driving a first lens to move in a first direction for compensation, the first sensors are arranged in parallel to a first optical axis, and one of the first sensors detects the first lens to obtain a first positional variation of the first lens in the first direction. The second image stabilization mechanism includes a second sensor and a second compensation assembly wherein the second image stabilization mechanism is configured for driving a second lens to move in a second direction for compensation, the second sensor detects the second lens to obtain a second positional variation of the second lens in the second direction. The first compensation assembly stops driving the first lens and the second compensation assembly stops driving the second lens, when the first positional variation or the second positional variation is greater than a first threshold value. The first compensation assembly starts driving the first lens and the second compensation assembly starts driving the second lens, when the first positional variation or the second positional variation is less than a second threshold value. The first threshold value is greater than the second threshold value.

In another exemplary embodiment, the first lens driven by the first compensation assembly has a first maximum position compensation amount. The second lens driven by the second compensation assembly has a second maximum position compensation amount. The first threshold value is greater than the first maximum position compensation amount of the first lens and is greater than the second maximum position compensation amount of the second lens. The second threshold value is less than the first maximum position compensation amount of the first lens and is less than the second maximum position compensation amount of the second lens.

In yet another exemplary embodiment, the first threshold value is adjustable and resettable.

In another exemplary embodiment, the second threshold value is adjustable and resettable.

In yet another exemplary embodiment, the dual lens barrel optical device includes the above-mentioned image stabilization module, a first lens barrel, a first lens assembly, a second lens barrel, a second lens assembly, and a movement adjustment element. The first image stabilization mechanism is disposed in the first lens barrel. The first lens assembly is disposed in the first lens barrel wherein the first lens assembly includes the first lens and the first optical axis, and light passes through the first lens assembly to form a first image. The second image stabilization mechanism is disposed in the second lens barrel. The second lens assembly is disposed in the second lens barrel wherein the second lens assembly includes the second lens and a second optical axis, and light passes through the second lens assembly to form a second image. The movement adjustment element is disposed in the first lens barrel or the second lens barrel. The first lens barrel and the second lens barrel are movable with respect to each other to change a distance between the first optical axis and the second optical axis.

In another exemplary embodiment, the movement adjustment element is connected to the first image stabilization mechanism and the second image stabilization mechanism.

In yet another exemplary embodiment, the dual lens barrel optical device further includes a driving element configured to drive the carrying barrel portion to rotate.

In another exemplary embodiment, the dual lens barrel optical device includes the above-mentioned image stabilization module, a first lens barrel, a first lens assembly, a second lens barrel, a second lens assembly, and a control module.

In yet another exemplary embodiment, the first image stabilization mechanism is disposed in the first lens barrel. The first lens assembly is disposed in the first lens barrel wherein the first lens assembly includes the first lens and the first optical axis, and light passes through the first lens assembly to form a first image. The second image stabilization mechanism is disposed in the second lens barrel. The second lens assembly is disposed in the second lens barrel wherein the second lens assembly includes the second lens and a second optical axis, and light passes through the second lens assembly to form a second image. The control module is electrically connected to the first image stabilization and the second image stabilization and configured to control the first image stabilization and the second image stabilization by comparing the first positional variation and the second positional variation with the first threshold value and the second threshold value. The first lens barrel and the second lens barrel are movable with respect to each other to change a distance between the first optical axis and the second optical axis.

In another exemplary embodiment, the first sensors include a first angle sensor and a first position sensor. The first angle sensor and the first position sensor are disposed on different parts and arranged along the first optical axis. The second sensor includes a second angle sensor and a second position sensor. The second angle sensor and the second position sensor are disposed on different parts and arranged along the second optical axis.

The image stabilization module in accordance with another exemplary embodiment of the invention includes a first image stabilization mechanism, a second image stabilization mechanism, and a movement adjustment element. The first image stabilization mechanism includes a first optical axis, a plurality of first sensors and a first compensation assembly wherein the first image stabilization mechanism is disposed in a first lens barrel and is configured for driving a first lens to move in a first direction for compensation, the first sensors are arranged in parallel to the first optical axis, the first direction is formed by combination of a first compensation direction and a second compensation direction, and the first compensation direction is orthogonal to the second compensation direction. The second image stabilization mechanism includes a second optical axis, a second sensor and a second compensation assembly wherein the second image stabilization mechanism is disposed in a second lens barrel and is configured for driving a second lens to move in a second direction for compensation, the second direction is formed by combination of a third compensation direction and a fourth compensation direction, and the third compensation direction is orthogonal to the fourth compensation direction. The movement adjustment element is connected to the first image stabilization mechanism and the second image stabilization mechanism. The first optical axis and the second optical axis are spaced a first distance. When a distance between the first optical axis and the second optical axis is greater than or less than the first distance, the movement adjustment element is moved so as to move the first image stabilization mechanism or the second image stabilization mechanism until the first compensation direction is parallel to the third compensation direction.

In another exemplary embodiment, the movement adjustment element is connected to the second image stabilization mechanism. The first sensors include a first angular velocity sensor. The second sensor includes a second angular velocity sensor or includes no angular velocity sensor. One of the first sensors detects the first lens to obtain a first positional variation of the first lens in the first direction. The second sensor detects the second lens to obtain a second positional variation of the second lens in the second direction. The first compensation assembly stops driving the first lens and the second compensation assembly stops driving the second lens, when the first positional variation or the second positional variation is greater than a first threshold value. The first compensation assembly starts driving the first lens and the second compensation assembly starts driving the second lens, when the first positional variation or the second positional variation is less than a second threshold value. The first threshold value is greater than the second threshold value.

In yet another exemplary embodiment, the dual lens barrel optical device includes the above-mentioned image stabilization module, a first lens barrel, a first lens assembly, a second lens barrel, a second lens assembly, and a control module. The first image stabilization mechanism is disposed in the first lens barrel. The first lens assembly is disposed in the first lens barrel wherein the first lens assembly includes the first lens and the first optical axis, and light passes through the first lens assembly to form a first image. The second image stabilization mechanism is disposed in the second lens barrel. The second lens assembly is disposed in the second lens barrel wherein the second lens assembly includes the second lens and a second optical axis, and light passes through the second lens assembly to form a second image. The control module is electrically connected to the first image stabilization and the second image stabilization and configured to control the first image stabilization and the second image stabilization by comparing the first positional variation and the second positional variation with the first threshold value and the second threshold value. The first lens barrel and the second lens barrel are movable with respect to each other to change a distance between the first optical axis and the second optical axis.

In another exemplary embodiment, the dual lens barrel optical device includes the above-mentioned image stabilization module, a first lens barrel, a first lens assembly, a second lens barrel, a second lens assembly, and a movement adjustment element. The first image stabilization mechanism is disposed in the first lens barrel. The first lens assembly is disposed in the first lens barrel wherein the first lens assembly includes the first lens and the first optical axis, and light passes through the first lens assembly to form a first image. The second image stabilization mechanism is disposed in the second lens barrel. The second lens assembly is disposed in the second lens barrel wherein the second lens assembly includes the second lens and a second optical axis, and light passes through the second lens assembly to form a second image. The movement adjustment element is disposed in the first lens barrel or the second lens barrel. The first lens barrel and the second lens barrel are movable with respect to each other to change a distance between the first optical axis and the second optical axis.

In yet another exemplary embodiment, the dual lens barrel optical device includes the above-mentioned image stabilization module, a first lens barrel, a first lens assembly, a second lens barrel, and a second lens assembly. The first image stabilization mechanism is disposed in the first lens barrel. The first lens assembly is disposed in the first lens barrel wherein the first lens assembly includes the first lens and the first optical axis, and light passes through the first lens assembly to form a first image. The second image stabilization mechanism is disposed in the second lens barrel. The second lens assembly is disposed in the second lens barrel wherein the second lens assembly includes the second lens and a second optical axis, and light passes through the second lens assembly to form a second image. The first lens barrel and the second lens barrel are movable with respect to each other to change a distance between the first optical axis and the second optical axis. The movement adjustment element is disposed in the first lens barrel or the second lens barrel. The movement adjustment element includes a carrying barrel portion and an operating ring portion. The carrying barrel portion is connected to the first lens barrel or the second lens barrel. The operating ring portion is connected to the carrying barrel portion and is rotatably disposed on an outer peripheral surface of the first lens barrel or the second lens barrel. The operating ring portion is rotated for driving the carrying barrel portion to rotate the first lens barrel or the second lens barrel, thereby moving the first image stabilization mechanism or the second image stabilization mechanism.

In another exemplary embodiment, the dual lens barrel optical device further includes a driving element configured to drive the carrying barrel portion to rotate.

In yet another exemplary embodiment, the first sensors include a first angle sensor and a first position sensor. The first angle sensor and the first position sensor are disposed on different parts and arranged along the first optical axis. The second sensor includes a second angle sensor and a second position sensor. The second angle sensor and the second position sensor are disposed on different parts and arranged along the second optical axis.

The invention provides a first image stabilization for detecting the positional variation of the first lens and the second image stabilization for detecting the positional variation of the second lens. When the shaking amplitude of the dual lens barrel optical device exceeds the first threshold value of the positional variation of the first lens or exceeds the second threshold value of the positional variation of the second lens, the movement of the first lens and the second lens for compensation is stopped, so that the optical axis of the first lens and the first optical axis of the first lens assembly coincide, and the optical axis of the second lens and the second optical axis of the second lens assembly coincide. This can avoid parallax between the first image formed by the first lens assembly and the second image formed by the second lens assembly.

The invention further provides a movement adjustment element which is able to move the first image stabilization mechanism and the second image stabilization mechanism until the first direction is parallel to the second direction, wherein the first image stabilization mechanism and the second image stabilization mechanism respectively provide compensation for the first lens and the second lens in the same direction. This can also avoid parallax between the first image formed by the first lens assembly and the second image formed by the second lens assembly.

### BRIEF DESCRIPTION OF THE DRAWINGS

FIG. 1 is a schematic view showing that two image stabilization mechanisms of conventional binoculars performing compensation operation in different directions for the lens modules of two lens barrels when the shaking amplitude exceeds the maximum compensation range.

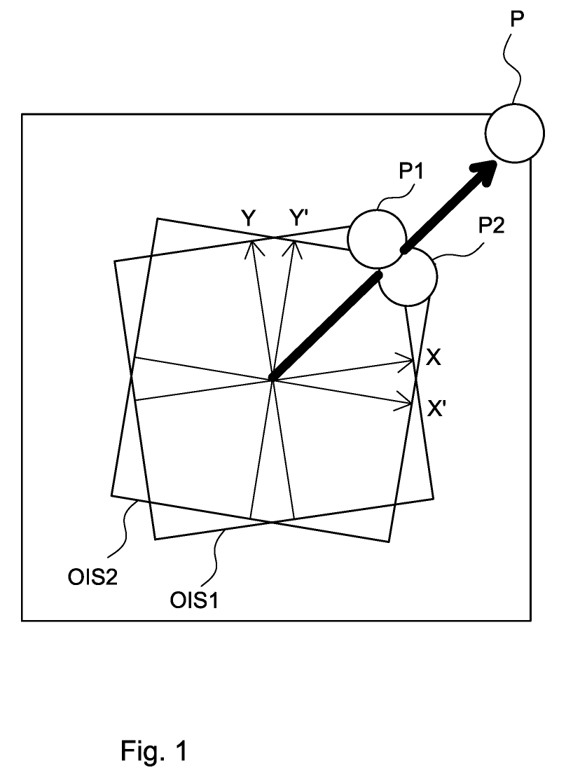

FIG. 2a is a sectional view showing two cross sections of the image stabilization module in accordance with a first embodiment of the invention.

FIG. 2b depicts the image stabilization module performing a compensation operation or performing no compensation operation when a dual lens barrel optical device is in different shaking amplitudes in accordance with the first embodiment of the invention.

FIG. 3 is a flowchart of adjusting the first threshold value and the second threshold value of the first image stabilization mechanism and the second image stabilization mechanism to change the compensation condition in accordance with the first embodiment of the invention.

FIG. 4 is a top view of a dual lens barrel optical device and two sectional views of the image stabilization module of the dual lens barrel optical device in accordance with a second embodiment of the invention.

FIG. 5 is a top view of a dual lens barrel optical device and two sectional views of the image stabilization module of the dual lens barrel optical device in accordance with a third embodiment of the invention.

### DETAILED DESCRIPTION OF THE INVENTION

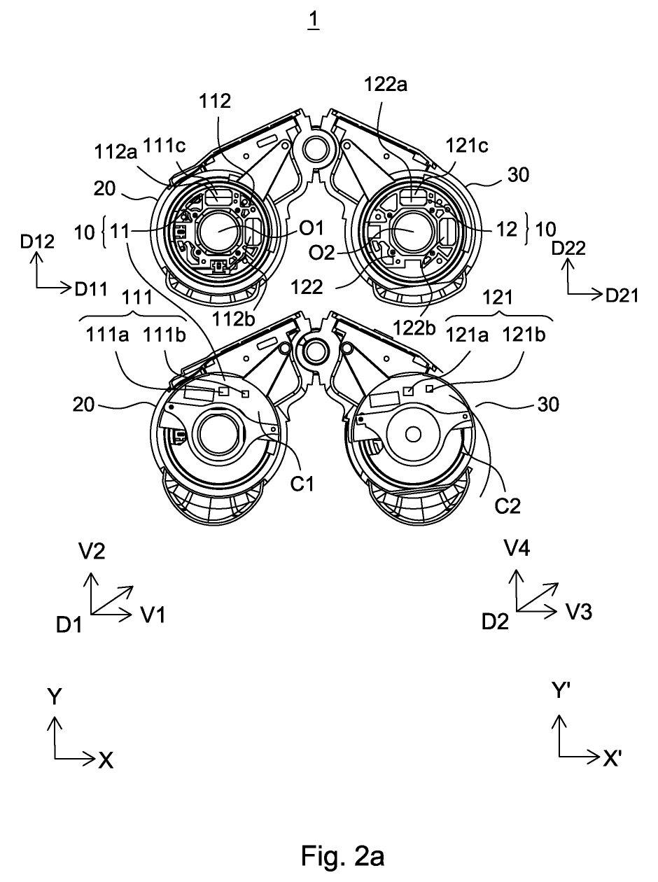

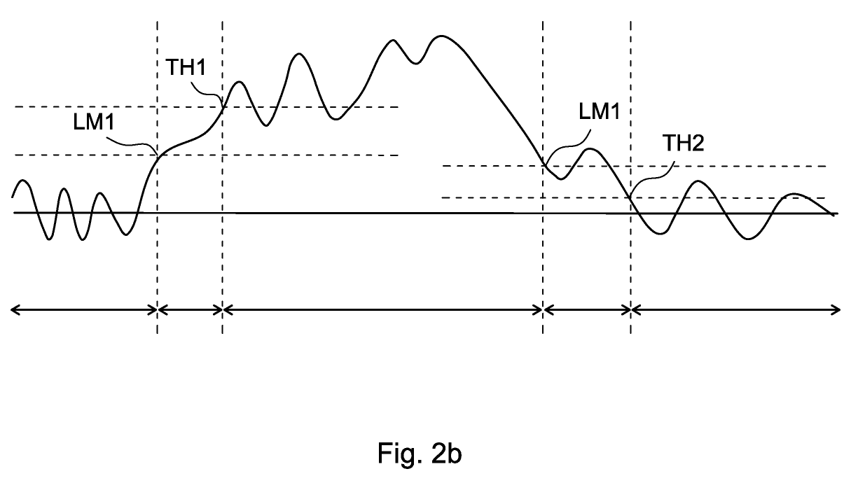

FIGS. 2a and 2b depict a dual lens barrel optical device in accordance with a first embodiment of the invention, wherein the dual lens barrel optical device 1 includes an image stabilization module 10, a first lens barrel 20, a first lens assembly (not shown), a second lens barrel 30, a second lens assembly (not shown) and a control module (not shown). The first lens barrel 20 has a first optical axis O1. The second lens barrel 30 has a second optical axis O2. The first optical axis O1 and the second optical axis O2 are perpendicular to the drawing paper.

The image stabilization module 10 includes a first image stabilization mechanism 11 and a second image stabilization mechanism 12. The first image stabilization mechanism 11 is disposed in the first lens barrel 20. The first lens assembly is disposed in the first lens barrel and has a first optical axis. Light passes through the first lens assembly to form a first image. The first lens assembly includes a first lens. The second image stabilization mechanism 12 is disposed in the second lens barrel 30. The second lens assembly is disposed in the second lens barrel and has a second optical axis. Light passes through the second lens assembly to form a second image. The second lens assembly includes a second lens. The first lens barrel 20 and the second lens barrel 30 can be rotated with respect to each other around a pivot F for changing the distance between the first optical axis and the second optical axis to match the distance between user's eyes that facilitates the user to view the first image and the second image.

The first image stabilization mechanism 11 includes a plurality of first sensors 111 and a first compensation assembly 112. Each first sensor 111 includes a first angular velocity sensor 111a, a first angle sensor 111b, and a first position sensor 111c. In this embodiment, the first angular velocity sensor 111a is an electronic gyroscope, the first angle sensor 111b is an acceleration sensor (G-sensor), and the first position sensor 111c is a Hall sensor. The first angular velocity sensor 111a and the first angle sensor 111b are disposed on a circuit board C1. The first position sensor 111c and the first compensation assembly 112 are disposed on the same plane. The circuit board C1 and the first compensation assembly 112 are arranged along the first optical axis O1. In other words, the first angular velocity sensor 111a, the first angle sensor 111b, and the first position sensor 111c are disposed on different parts and arranged along the first optical axis O1. In this way, the first sensor 111a and the first compensation component 112 are disposed on different planes, which can help reduce the diameter of the first lens barrel 20, and thus facilitate the miniaturization of the dual lens barrel optical device 1. The first sensor 111 detects a first positional variation of the first lens in the first direction D1 in accordance with a first coordinate system (X-Y coordinate system). The first direction D1 can be a direction which forms a predetermined angle with the X-axis and Y-axis of the first coordinate system. The first positional variation can be a location variation and/or an angle variation. The first compensation assembly 112 is configured for driving the first lens to move in a first direction D1 for shake compensation. The first compensation assembly 112 includes a first compensation element 112a which causes movement of the first lens in a first compensation direction D11 to generate a first displacement vector V1, and a second compensation element 112b which causes movement of the first lens in a second compensation direction D12 to generate a second displacement vector V2. The first compensation element 112a and the second compensation element 112b include, for example, coils and magnets. The magnet is coupled to the first lens. By passing a current through the coil, a magnetic field is generated, which interacts with the magnetic field of the magnet to generate a first displacement vector V1 along the first compensation direction D11 and a second displacement vector V2 along the second compensation direction D12. The first displacement vector V1 and the second displacement vector V2 combine to form a first direction D1, that is, the first compensation assembly 112 drives the first lens to move in the first direction D1. The first compensation direction D11 is orthogonal to the second compensation direction D12. The two first coordinate axes (X-axis and Y-axis) of the first coordinate system are perpendicular to the first optical axis. Also, the two first coordinate axes (X-axis and Y-axis) of the first coordinate system are parallel to the first compensation direction D11 and the second compensation direction D12, respectively.

The second image stabilization mechanism 12 includes at least one second sensor 121 and a second compensation assembly 122. The second sensor 121 includes a second angular velocity sensor 121a, a second angle sensor 121b, and a second position sensor 121c. In this embodiment, the second angular velocity sensor 121a is an electronic gyroscope, the second angle sensor 121b is an acceleration sensor, and the second position sensor 121c is a Hall sensor. The second angular velocity sensor 121a and the second angle sensor 121b are disposed on another circuit board C2. The second position sensor 121c is disposed on the second compensation assembly 122. The circuit board C2 and the second compensation assembly 122 are arranged along the second optical axis O2. In other words, the second angular velocity sensor 121a, the second angle sensor 121b, and the second position sensor 121c are disposed on different parts and arranged along the second optical axis O2. In this way, the second sensor 111a and the second compensation component 112 are disposed on different planes, which can help reduce the diameter of the second lens barrel 30, and thus facilitate the miniaturization of the dual lens barrel optical device 1. The second sensor 121 detects a second positional variation of the second lens in the second direction D2 in accordance with a second coordinate system (X’-Y’ coordinate system). The second direction D2 can be a direction which forms a predetermined angle with the X’-axis and Y’-axis of the second coordinate system. The second positional variation can be a location variation and/or an angle variation. The second compensation assembly 122 is configured for driving the second lens to move in the second direction D2 for compensation. The second compensation assembly 122 includes a third compensation element 122a which causes movement of the second lens in a third compensation direction D21 to generate a third displacement vector V3, and a fourth compensation element 122b which causes movement of the second lens in a fourth compensation direction D22 to generate a fourth displacement vector V4. The third compensation element 122a and the fourth compensation element 122b include, for example, coils and magnets. The magnets are coupled to the second lens. By passing a current through the coils, a magnetic field is generated, which interacts with the magnetic field of the magnets to generate the third displacement vector V3 along the third compensation direction D21 and a fourth displacement vector V4 along the fourth compensation direction D22. The third displacement vector V3 and the fourth displacement vector V4 combine to form a second direction D2, that is, the second compensation assembly 122 drives the second lens to move in the second direction D2. The third compensation direction D21 is orthogonal to the fourth compensation direction D22. The two second coordinate axes (X’-axis and Y’-axis) of the second coordinate system are perpendicular to the second optical axis. Also, the two second coordinate axes (X’-axis and Y’-axis) of the second coordinate system are parallel to the third compensation direction D21 and the fourth compensation direction D22, respectively.

Since the first position sensors 111c are used to detect the positions of the first compensation element 112a and the second compensation element 112b, the first position sensors 111c are indicated in the plane where the first compensation element 112a and the second compensation element 112b are indicated in FIG. 2a. However, it is worth noting that the first position sensor 111c only needs to be disposed corresponding to the first compensation member 112a and the second compensation member 112b along the optical axis. That is, the first position sensor 111c is not required to be disposed on the plane where the first compensation member 112a and the second compensation member 112b are disposed. Similarly, since the second position sensor 121c is used to detect the positions of the third compensation element 122a and the fourth compensation element 122b, the second position sensor 121c is indicated in the plane where the third compensation element 122a and the fourth compensation element 122b are indicated in FIG. 2a. However, it is understood that the second position sensor 121c only needs to be disposed corresponding to the third compensation member 122a and the fourth compensation member 122b along the optical axis. That is, the second position sensor 121c is not required to be disposed on the plane where the third compensation member 122a and the fourth compensation member 122b are disposed.

It is worth noting that the first direction D1 and the second direction D2 are direction vectors respectively obtained from the first coordinate system and the second coordinate system, and they are essentially directed at the same direction.

The control module is electrically connected to the first image stabilization mechanism 11 and the second image stabilization mechanism 12. The first positional variation detected by the first sensors 11 of the first image stabilization mechanism 11 and the second positional variation detected by the second sensors 12 of the second image stabilization mechanism 12 are transmitted to the control module. FIG. 2b shows the first positional variation or the second positional variation over time.

When the user rotates the first lens barrel 20 and the second lens barrel 30 to match the distance between user's eyes, the first coordinate system and the second coordinate system do not coincide. Thus, the first direction D1 and the second direction D2 will have different vector values, but they are essentially the same direction. When the shaking amplitude of the first lens barrel 20 is not greater than the first maximum position compensation amount and the shaking amplitude of the second lens barrel 30 is not greater than the second maximum position compensation amount, the first compensation module 112 and the second compensation module 122 respectively provide compensation for the first lens and the second lens in the same direction, and the shake compensation is reliably accurate.

As shown in FIG. 2b, when the first angular velocity sensor 111a and the second angular velocity sensor 121a detect that the shaking amplitude of the first lens barrel 20 is greater than the first maximum position compensation amount or the shaking amplitude of the second lens barrel 30 is greater than the second maximum position compensation amount (in FIG. 2b, LM1 indicates the first maximum position compensation amount or the second maximum position compensation amount), the shaking of the dual lens barrel optical device 1 already exceeds the maximum position compensation amount of the first image stabilization mechanism 11 and the second image stabilization mechanism 12. Thus, the final target compensation position may differ due to the limitations of the maximum position compensation amount of the first compensation module 112 and the second compensation module 122. Then, the control module compares the first positional variation and the second positional variation with the first threshold value TH1. If the first positional variation or the second positional variation is greater than the first threshold value TH1, then the control module will control the first image stabilization mechanism 11 to stop the movement compensation for the first lens and also control the second image stabilization mechanism 12 to stop the movement compensation for the second lens, so that the optical axis of the first lens and the first optical axis of the first lens assembly coincide and the optical axis of the second lens and the second optical axis of the second lens assembly coincide. Thus, the first image formed by the first lens assembly and the second image formed by the second lens assembly are in a state of parallax-free or substantially synchronous movement.

When the first angular velocity sensor 111a and the second angular velocity sensor 121a detect that the shaking amplitude of the first lens barrel 20 is greater than the first maximum position compensation amount or the shaking amplitude of the second lens barrel 30 is less than the second maximum position compensation amount (in FIG. 2b, LM1 indicates the first maximum position compensation amount or the second maximum position compensation amount), the shaking of the dual lens barrel optical device 1 is already within the maximum compensation range of the first image stabilization mechanism 11 and the second image stabilization mechanism 12. Thus, the control module compares the first positional variation and the second positional variation with the second threshold value TH2. If the first positional variation or the second positional variation is less than the second threshold value TH2, then the control module will control the first image stabilization mechanism 11 to compensate for movement of the first lens and also control the second image stabilization mechanism 12 to compensate for movement of the second lens, so that the first image formed by the first lens assembly and the second image formed by the second lens assembly are in a state of parallax-free or substantially synchronous movement.

In this embodiment, the first threshold value TH1 is greater than the first maximum position compensation amount LM1 (or the second maximum position compensation amount) and the second threshold value TH2 is less than the first maximum position compensation amount LM1 (or the second maximum position compensation amount). Therefore, the first threshold value TH1 is greater than the second threshold value TH2. This ensures that the first image stabilization mechanism 11 and the second image stabilization mechanism 12 do not frequently switch between the mode of stopping compensation and the mode of starting compensation.

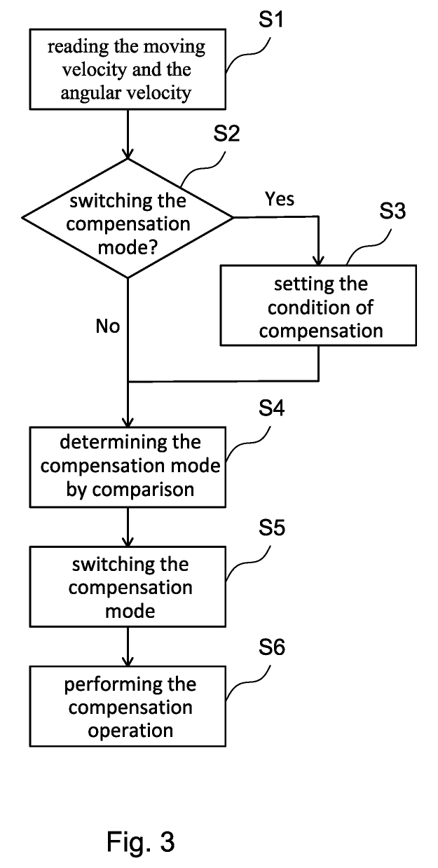

FIG. 3 is a flowchart showing that different processes of the image stabilization module 10 in this embodiment are performed depending on whether the mode of starting compensation and the mode of stopping compensation are switched. In step S1, the first sensor 111 and the second sensor 121 detect the displacement and the angular velocity to determine the positional variations (the shaking extent). In step S2, it is determined if switching between the mode of starting compensation and the mode of stopping compensation is required. The process goes to step S3 if the switching is required. The process goes to step S4 if the switching is not required. In step S3, the first threshold value TH1 and the second threshold value TH2 are set, and the process goes to step S4. In step S4, the first positional variation and the second positional variation are compared with the first threshold value TH1 and the second threshold value TH2. In step S5, the mode of starting compensation and the mode of stopping compensation are switched in accordance with the comparison result. In step S6, the first lens and the second lens are driven by the image stabilization module 10 to move for compensation for the first image and the second image.

The first threshold value TH1 and the second threshold value TH2 can be set to different values in accordance with different usage scenarios, allowing the user to switch between different modes. After a mode is switched to another mode, the switching conditions between the mode of starting compensation and the mode of stopping compensation is adjusted, so that the image stabilization module 10 has a larger compensation angle, making the image more stable, or making it easier to switch to a moving state. This can avoid the user from feeling dizziness due to slight movement.

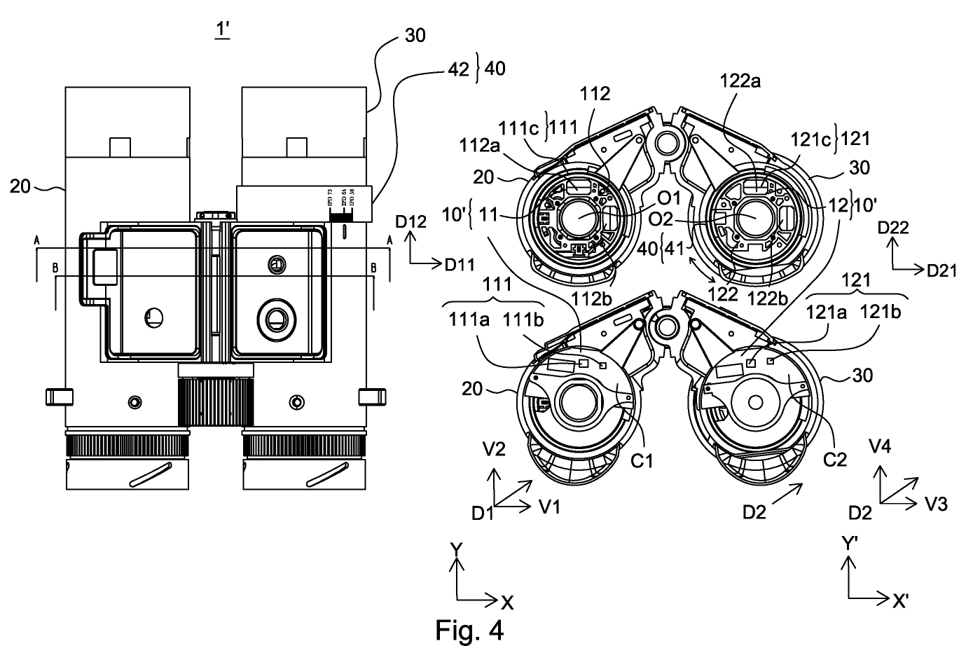

FIG. 4 depicts a dual lens barrel optical device in accordance with a second embodiment of the invention, wherein the parts same as those of the first embodiment are labeled with the same reference numerals and the descriptions thereof are omitted. The second embodiment differs from the first embodiment in that the image stabilization 10’ of the second embodiment further includes a movement adjustment element 40. The movement adjustment element 40 includes a carrying barrel portion 41 and an operating ring portion 42. The carrying barrel portion 41 is connected to the second lens barrel 30. The second image stabilization mechanism 12 is also connected to the second lens barrel 30. The operating ring portion 42 is connected to the carrying barrel portion 41 and rotatably disposed on the outer peripheral surface of the second lens barrel 30. The user can manually rotate the operating ring portion 42 or can drive the operating ring portion 42 by using a driver (e.g., a motor triggered by a switch) to rotate the second lens barrel 30 through the carrying barrel portion 41, thereby moving the second image stabilization mechanism 12 circumferentially.

As described above, the user can rotate the first lens barrel 20 and the second lens barrel 30 with respect to each other for adjusting the distance therebetween to match user’s eyes. The distance is, for example, a distance between the first optical axis O1 and the second optical axis O2 shown in FIG. 2a (hereinafter the first distance). The relative rotation of the first lens barrel 20 and the second lens barrel 30 will cause the first coordinate system (X-axis and Y-axis) of the first image stabilization mechanism 11 to be non-coincident (i.e., not parallel) with the second coordinate system (X'-axis and Y'-axis) of the second image stabilization mechanism 12. At this time, the distance between the first optical axis and the second optical axis is greater than or less than the first distance, resulting in the difference between the compensation of the first image stabilization mechanism 11 in the first direction D1 and the compensation of the second image stabilization mechanism 12 in the second direction D2. In this embodiment, therefore, the image stabilization module 10' is equipped with a movement adjustment element 40. After rotating the first lens barrel 20 and the second lens barrel 30 with respect to each other, the user can further rotate the movement adjustment element 40 to move the second image stabilization mechanism 12 in the circumferential direction until the first coordinate system (X-axis and Y-axis) of the first image stabilization mechanism 11 coincides with (i.e., parallel to) the second coordinate system (X'-axis and Y'-axis) of the second image stabilization mechanism 12. In this way, the first direction D1 of the first image stabilization mechanism 11 and the second direction D2 of the second image stabilization mechanism 12 can be corrected to be parallel to each other. In this embodiment, when shaking of the dual lens barrel optical device 1' exceeds the maximum compensation range, the first direction D1 of the first image stabilization mechanism 11 for compensation is the same as the second direction D2 of the second image stabilization mechanism 12 for compensation, and the first image formed by the first lens assembly and the second image formed by the second lens assembly have no parallax.

In this embodiment, the movement adjustment element 40 is connected to the second image stabilization mechanism 12. However, the invention is not limited thereto. In some other embodiments, the movement adjustment element 40 may be connected to the first image stabilization mechanism 11.

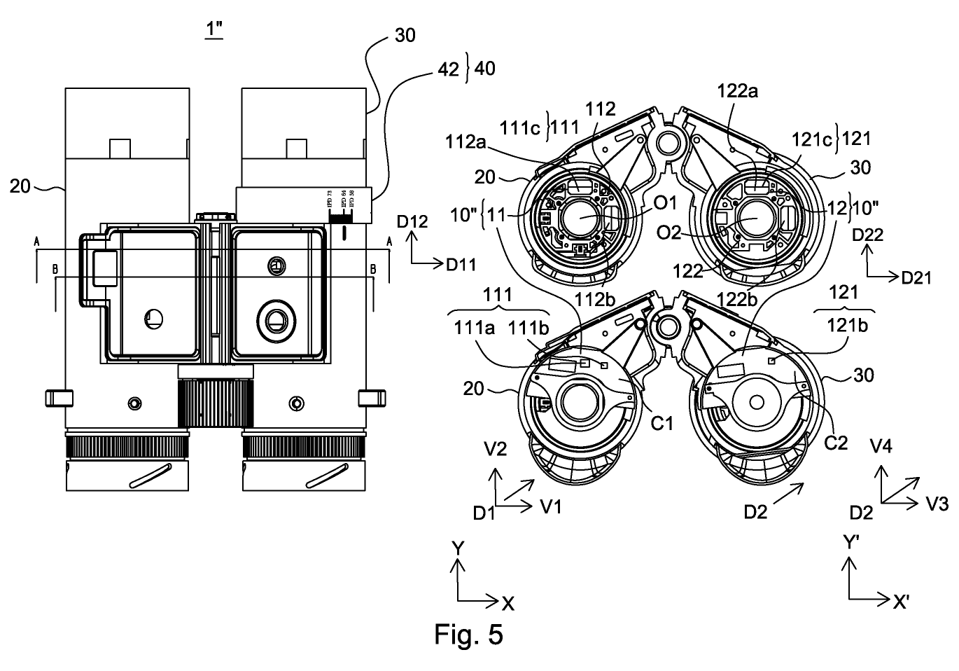

FIG. 5 depicts a dual lens barrel optical device in accordance with a third embodiment of the invention, wherein the parts same as those of the second embodiment are labeled with the same reference numerals and the descriptions thereof are omitted. The third embodiment differs from the second embodiment in that the second sensors 121 include no angular velocity sensors. That is, the angular velocity sensor included by the image stabilization module 10” of this embodiment is only the first angular velocity sensor 111a. The first angular velocity sensor is configured to detect the angular velocity of the entire dual lens barrel optical device 1” during shaking. Similarly, in this embodiment, the movement adjustment element 40 is configured to move the second image stabilization mechanism 12 in the circumferential direction, so that the first direction D1 of the first image stabilization mechanism 11 for compensation is the same as the second direction D2 of the second image stabilization mechanism 12 for compensation, and the first image formed by the first lens assembly and the second image formed by the second lens assembly have no parallax.

In this embodiment, the image stabilization module 10” has no other angular velocity sensors but the first angular velocity sensor, and the movement adjustment element 40 is connected to the second image stabilization mechanism 12. However, the invention is not limited thereto. In some other embodiments, the image stabilization module may have no other angular velocity sensors but the second angular velocity sensor, and the movement adjustment element is connected to the first image stabilization mechanism.

The invention provides a first image stabilization for detecting the positional variation of the first lens and the second image stabilization for detecting the positional variation of the second lens. When the shaking amplitude of the dual lens barrel optical device exceeds the first threshold value of the positional variation of the first lens or exceeds the second threshold value of the positional variation of the second lens, the movement of the first lens and the second lens for compensation is stopped, so that the optical axis of the first lens and the first optical axis of the first lens assembly coincide, and the optical axis of the second lens and the second optical axis of the second lens assembly coincide. This can avoid parallax between the first image formed by the first lens assembly and the second image formed by the second lens assembly.

The invention further provides a movement adjustment element which is able to move the first image stabilization mechanism and the second image stabilization mechanism until the first direction is parallel to the second direction, wherein the first image stabilization mechanism and the second image stabilization mechanism respectively provide compensation for the first lens and the second lens in the same direction. This can also avoid parallax between the first image formed by the first lens assembly and the second image formed by the second lens assembly.

What is described above is only the preferred embodiment of the invention, and the scope of the invention is not limited thereto. That is, the simple equivalent changes and modifications made according to the description of the invention and the claims are all within the scope of the invention. Further, any one of the embodiments or claims is not required to achieve all the objects or advantages or features of the invention. Further, the abstract and title are only used to assist in the search of patent documents and are not intended to limit the scope of the invention.

What is claimed is:

1. An image stabilization module, comprising:
a first image stabilization mechanism comprising a plurality of first sensors and a first compensation assembly wherein the first image stabilization mechanism is configured for driving a first lens to move in a first direction for compensation, the first sensors are arranged in parallel to a first optical axis, and one of the first sensors detects the first lens to obtain a first positional variation of the first lens in the first direction;
a second image stabilization mechanism comprising a second sensor and a second compensation assembly wherein the second image stabilization mechanism is configured for driving a second lens to move in a second direction for compensation, the second sensor detects the second lens to obtain a second positional variation of the second lens in the second direction;
wherein the first compensation assembly stops driving the first lens and the second compensation assembly stops driving the second lens, when the first positional variation or the second positional variation is greater than a first threshold value;
wherein the first compensation assembly starts driving the first lens and the second compensation assembly starts driving the second lens, when the first positional variation or the second positional variation is less than a second threshold value;
wherein the first threshold value is greater than the second threshold value.

2. The image stabilization module as claimed in claim 1, wherein:
the first lens driven by the first compensation assembly has a first maximum position compensation amount;
the second lens driven by the second compensation assembly has a second maximum position compensation amount;
the first threshold value is greater than the first maximum position compensation amount of the first lens and is greater than the second maximum position compensation amount of the second lens;
the second threshold value is less than the first maximum position compensation amount of the first lens and is less than the second maximum position compensation amount of the second lens.

3. The image stabilization module as claimed in claim 1, wherein the first threshold value is adjustable and resettable.

4. The image stabilization module as claimed in claim 1, wherein the second threshold value is adjustable and resettable.

5. A dual lens barrel optical device comprising:
the image stabilization module as claimed in claim 1;
a first lens barrel wherein the first image stabilization mechanism is disposed in the first lens barrel;
a first lens assembly disposed in the first lens barrel wherein the first lens assembly comprises the first lens and the first optical axis, and light passes through the first lens assembly to form a first image;
a second lens barrel wherein the second image stabilization mechanism is disposed in the second lens barrel;
a second lens assembly disposed in the second lens barrel wherein the second lens assembly comprises the second lens and a second optical axis, and light passes through the second lens assembly to form a second image;
a movement adjustment element disposed in the first lens barrel or the second lens barrel;
wherein the first lens barrel and the second lens barrel are movable with respect to each other to change a distance between the first optical axis and the second optical axis.

6. The dual lens barrel optical device as claimed in claim 5, wherein the movement adjustment element is connected to the first image stabilization mechanism and the second image stabilization mechanism.

7. The dual lens barrel optical device as claimed in claim 6, further comprising a driving element configured to drive the carrying barrel portion to rotate.

8. A dual lens barrel optical device comprising:
the image stabilization module as claimed in claim 1;
a first lens barrel wherein the first image stabilization mechanism is disposed in the first lens barrel;
a first lens assembly disposed in the first lens barrel wherein the first lens assembly comprises the first lens and the first optical axis, and light passes through the first lens assembly to form a first image;
a second lens barrel wherein the second image stabilization mechanism is disposed in the second lens barrel;
a second lens assembly disposed in the second lens barrel wherein the second lens assembly comprises the second lens and a second optical axis, and light passes through the second lens assembly to form a second image;
a control module electrically connected to the first image stabilization and the second image stabilization and configured to control the first image stabilization and the second image stabilization by comparing the first positional variation and the second positional variation with the first threshold value and the second threshold value;
wherein the first lens barrel and the second lens barrel are movable with respect to each other to change a distance between the first optical axis and the second optical axis.

9. The image stabilization module as claimed in claim 1, wherein:
the first sensors comprise a first angle sensor and a first position sensor;
the first angle sensor and the first position sensor are disposed on different parts and arranged along the first optical axis;
the second sensor comprises a second angle sensor and a second position sensor;
the second angle sensor and the second position sensor are disposed on different parts and arranged along the second optical axis.

10. An image stabilization module, comprising:
a first image stabilization mechanism comprising a first optical axis, a plurality of first sensors and a first compensation assembly wherein the first image stabilization mechanism is disposed in a first lens barrel and is configured for driving a first lens to move in a first direction for compensation, the first sensors are arranged in parallel to the first optical axis, the first direction is formed by combination of a first compensation direction and a second compensation direction, and the first compensation direction is orthogonal to the second compensation direction;
a second image stabilization mechanism comprising a second optical axis, a second sensor and a second compensation assembly wherein the second image stabilization mechanism is disposed in a second lens barrel and is configured for driving a second lens to move in a second direction for compensation, the second direction is formed by combination of a third compensation direction and a fourth compensation direction, and the third compensation direction is orthogonal to the fourth compensation direction;
a movement adjustment element connected to the first image stabilization mechanism and the second image stabilization mechanism;
wherein the first optical axis and the second optical axis are spaced a first distance;
wherein when a distance between the first optical axis and the second optical axis is greater than or less than the first distance, the movement adjustment element is moved so as to move the first image stabilization mechanism or the second image stabilization mechanism until the first compensation direction is parallel to the third compensation direction.

11. The image stabilization module as claimed in claim 10, wherein:
the movement adjustment element is connected to the second image stabilization mechanism;
the first sensors comprise a first angular velocity sensor;
the second sensor comprises a second angular velocity sensor or comprises no angular velocity sensor;
one of the first sensors detects the first lens to obtain a first positional variation of the first lens in the first direction;
the second sensor detects the second lens to obtain a second positional variation of the second lens in the second direction;
the first compensation assembly stops driving the first lens and the second compensation assembly stops driving the second lens, when the first positional variation or the second positional variation is greater than a first threshold value;
the first compensation assembly starts driving the first lens and the second compensation assembly starts driving the second lens, when the first positional variation or the second positional variation is less than a second threshold value;
the first threshold value is greater than the second threshold value.

12. A dual lens barrel optical device comprising:
the image stabilization module as claimed in claim 11;
a first lens barrel wherein the first image stabilization mechanism is disposed in the first lens barrel;
a first lens assembly disposed in the first lens barrel wherein the first lens assembly comprises the first lens and the first optical axis, and light passes through the first lens assembly to form a first image;
a second lens barrel wherein the second image stabilization mechanism is disposed in the second lens barrel;
a second lens assembly disposed in the second lens barrel wherein the second lens assembly comprises the second lens and a second optical axis, and light passes through the second lens assembly to form a second image;
a control module electrically connected to the first image stabilization and the second image stabilization and configured to control the first image stabilization and the second image stabilization by comparing the first positional variation and the second positional variation with the first threshold value and the second threshold value;
wherein the first lens barrel and the second lens barrel are movable with respect to each other to change a distance between the first optical axis and the second optical axis.

13. A dual lens barrel optical device comprising:
the image stabilization module as claimed in claim 10;
a first lens barrel wherein the first image stabilization mechanism is disposed in the first lens barrel;
a first lens assembly disposed in the first lens barrel wherein the first lens assembly comprises the first lens and the first optical axis, and light passes through the first lens assembly to form a first image;
a second lens barrel wherein the second image stabilization mechanism is disposed in the second lens barrel;
a second lens assembly disposed in the second lens barrel wherein the second lens assembly comprises the second lens and a second optical axis, and light passes through the second lens assembly to form a second image;
a movement adjustment element disposed in the first lens barrel or the second lens barrel;
wherein the first lens barrel and the second lens barrel are movable with respect to each other to change a distance between the first optical axis and the second optical axis.

14. A dual lens barrel optical device comprising:
the image stabilization module as claimed in claim 10;
a first lens barrel wherein the first image stabilization mechanism is disposed in the first lens barrel;
a first lens assembly disposed in the first lens barrel wherein the first lens assembly comprises the first lens and the first optical axis, and light passes through the first lens assembly to form a first image;
a second lens barrel wherein the second image stabilization mechanism is disposed in the second lens barrel;
a second lens assembly disposed in the second lens barrel wherein the second lens assembly comprises the second lens and a second optical axis, and light passes through the second lens assembly to form a second image;
wherein the first lens barrel and the second lens barrel are movable with respect to each other to change a distance between the first optical axis and the second optical axis;
wherein the movement adjustment element is disposed in the first lens barrel or the second lens barrel;
wherein the movement adjustment element comprises a carrying barrel portion and an operating ring portion;
wherein the carrying barrel portion is connected to the first lens barrel or the second lens barrel;
wherein the operating ring portion is connected to the carrying barrel portion and is rotatably disposed on an outer peripheral surface of the first lens barrel or the second lens barrel;
wherein the operating ring portion is rotated for driving the carrying barrel portion to rotate the first lens barrel or the second lens barrel, thereby moving the first image stabilization mechanism or the second image stabilization mechanism.

15. The dual lens barrel optical device as claimed in claim 14, further comprising a driving element configured to drive the carrying barrel portion to rotate.

16. The image stabilization module as claimed in claim 10, wherein:
the first sensors comprise a first angle sensor and a first position sensor;
the first angle sensor and the first position sensor are disposed on different parts and arranged along the first optical axis;
the second sensor comprises a second angle sensor and a second position sensor;
the second angle sensor and the second position sensor are disposed on different parts and arranged along the second optical axis.
